(19) United States
(12) Patent Application Publication
(10) Pub. No.: US 2005/0262704 A1
(43) Pub. Date: Dec. 1, 2005

(54) Handheld seam ripper apparatus

(76) Inventor: Daniel M. DiSanto, Alameda, CA (US)

Correspondence Address: JOHNSON & STAINBROOK, LLP, 3558 ROUND BARN BLVD., SUITE 203, SANTA ROSA, CA, 95403, US

(21) Appl. No.: 11/142,056

(22) Filed: May 31, 2005

Related U.S. Application Data
(60) Provisional application No. 60/575,790, filed on May 28, 2004.

(51) Int. Cl. B26B 29/00; B26B 29/06

(52) U.S. Cl. 30/289

(57) ABSTRACT

A handheld seam ripper apparatus includes a pair of elongate arms each having a grip end and a working end, a hinge pin connecting the respective grip ends, thumb grips formed in the arms proximate the respective working ends, with the working ends terminating in opposing inwardly-directed hooked blades adapted to both pry and cut threads with a radial motion when pressed by the user.

### CROSS REFERENCE TO RELATED APPLICATIONS

The present application claims the benefit of the filing date of U.S. Provisional Patent Application Ser. No. 60/575,790, filed May 28, 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to sewing and stitching tools, and more particularly to an improved seam ripper apparatus.

### BACKGROUND INFORMATION AND DISCUSSION OF RELATED ART

Referring to FIG. 1, it will be seen that conventional seam rippers generally have two spaced-apart blunt and unsharpened projections angled slightly outwardly from one another and joined together at a sharpened junction or crotch. The longer of the two projections includes a blunt point and a generally narrow body portion to function as a stitch picker. The prior art apparatus also includes a handle extending from the crotch and having a longitudinal axis substantially in line or parallel with the direction in which the device is moved during use.

“Surgical” or “quilter's” seam rippers, shown in FIG. 2, are similarly designed, but exclude the shorter projection and include an increased cutting area. In use, however, each prior art design tears at threads and requires a forceful sawing and digging motion (in effect, a kind of poking motion) orthogonal to the stitched seam. After the first pull or tear of the stitch, the user's hand must be rotated to pull the fabric apart, and then rotated once again to rip the next stitch. These movements are especially difficult with higher TEX threads (a world-wide standard numerically describing the direct measure of thread weight; the higher the TEX number, the heavier and thicker the thread) and areas with dense SPI (a standard industrial abbreviation for “stitches per inch”) such as on bartacks, upholstery and luggage. All these motions to reposition the hand and the fabric are time consuming and fatiguing. Additionally, conventional seam rippers can easily cut or abrade the fabric (and the user) with just a quick slip of the hand. This is especially true of the newer “surgical” seam rippers.

Thread clippers are another tool that can easily clip the fabric while clipping the stitches. These tools usually have some sort of hinge, but the blades are merely exposed points of metal on the same plane as the handle. Thread clippers require extra movements and dexterity to remove a seam without damaging fabric. As with surgical seam rippers, thread clippers cannot pull or pry stitches without cutting the threads. Furthermore, most clippers are manufactured imprecisely and with poor tolerances, and the blades frequently collide or pass with considerable clearance. This misalignment results in poor performance or a complete failure to clip the thread stitches.

The above-described deficiencies are known, as a result of which several alternative designs have been proposed, a few exemplary designs including the following.

U.S. Pat. No. 4,510,688 to White discloses a seam cutting tool having a handle with a forward edge extending parallel to the cutting edge of the blade so that the cutting tool may be grasped from the side. The holder has a guide portion having upper and lower planar surfaces inclined obliquely relative to the plane of the blade. The surfaces converge forwardly of the edge of the blade thereby forming a cross-sectional wedge. The surfaces of the guide portion, both above and below the blade, are inclined at an oblique angle relative to the blade so that in cross section the tool is wedge-shaped. This wedge serves to gradually separate the cloth from the seam so that only the seam is guided onto the cutting edge of the blade. The holder has at least one opening of a predetermined dimension exposing a portion of the cutting edge of the blade. Instead of a poking motion, this device requires a sliding action, but its bulky conformation makes it difficult to pry stitches up for cutting.

U.S. Pat. No. 4,175,498, to Walters, shows a seam ripper adapted for mounting on a home sewing machine in place of the pressure foot. It includes a solid cuboid foot with a slanted face having a slit for retaining a vertically disposed beveled cutting blade. The apparatus further includes a shank disposed upwardly from the top surface for attachment to the pressure foot shaft or bar. The feed dogs cause the device to go up and down as the material is pushed through.

The foregoing discussion reflects the current state of the art of which the present inventor is aware. Reference to, and discussion of, these references is intended to aid in discharging Applicant's acknowledged duty of candor in disclosing information that may be relevant to the examination of claims to the present invention. However, it is respectfully submitted that none of the prior art references disclose, teach, suggest, show, or otherwise render obvious, either singly or when considered in combination, the invention described and claimed herein.

### BRIEF SUMMARY OF THE INVENTION

The present invention provides a hand-held seam ripper apparatus for industrial and home use. The apparatus includes a pair of elongate arms each having a grip and a working end, a hinge connecting the respective grips ends, thumb grips formed in the arms proximate the respective working ends, with the working ends terminating in opposing inwardly-directed hooked blades adapted to both pry and cut threads with a radial motion.

The two replaceable blades are hard surgical steel with a fine cutting edge. The blades are disposed downwardly from the working end of the arms at an approximately 120 degree angle. The points on the blades that initially come in contact with the fabric and stitches are tapered and smooth without a cutting edge. The cutting edge is a crescent shape on the upper portion of the blade. This allows the user to pull the thread and pry under tight stitches without damaging the fabric or clipping the stitch until the device is closed. The simple internal coiled wire spring or compression spring between the adjoining grip ends of the arms provides the user an almost effortless pinching action to clip threads and loose thread ends. This spring is anchored around an internal hinge pin secured externally with a cap, which may be employed as a surface for placing a decorative logo. The arms are preferably fabricated from a comfortable soft plastic or cast aluminum with an ergonomic design and include extended thumb pads and a safety mechanism to lock the device in a closed position. The locking mechanism optionally regulates and limits the maximum distance the blades separate when in use.

It is therefore an object of the present invention to provide a new and improved seam ripper apparatus.

It is another object of the present invention to provide a new and improved seam ripper that is able to pry under tight stitches.

A further object or feature of the present invention is a new and improved seam ripper that can clip the pried threads.

An even further object of the present invention is to provide a novel seam ripper that is comfortable and easy to use.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a perspective view of a prior art conventional seam ripper shown as used to pick and cut the stitching in a seam;

FIG. 2 is a side view in elevation of a prior art “surgical” seam ripper;

FIG. 3 is a perspective view of the seam ripper of the present invention;

FIG. 4 is a perspective view showing the inventive apparatus in use;

FIG. 5 is a side view in elevation of the seam ripper of the present invention;

FIG. 5A is a detailed cross-sectional view as taken along the line shown in FIG. 5, showing the coiled spring wound around the hinge pin in the proximal ends of the arms;

FIG. 6 is a top plan view of the seam ripper;

FIG. 7A is a distal end view showing the direction the blades move during use;

FIG. 7B is a distal end view showing the blades in a closed, or cutting position;

FIG. 8 shows alternative removable blades;

FIG. 9 is a perspective view of a second preferred embodiment, showing the inventive apparatus in a motorized form;

FIG. 10 is a perspective view of a third preferred embodiment of the inventive seam ripper;

FIG. 11 is a side view in elevation thereof;

FIGS. 12A and 12B, respectively, distal end views in elevation showing the radial cutting action of the third preferred embodiment of the inventive seam ripper;

FIG. 13 is a top plan view of a fourth preferred embodiment with stacked arms;

FIG. 14 is a perspective view of fifth preferred embodiment showing an ergonomic design;

FIG. 14A is a perspective view showing detail of the hinge pin and sliding bow spring of the fifth preferred embodiment;

FIGS. 15A and 15B are detailed perspective views of the distal end thereof, showing details of the radial cutting motion for cutting threads in a seam; and

FIG. 16 shows the fifth preferred embodiment cutting loose thread ends.

### DETAILED DESCRIPTION OF THE INVENTION

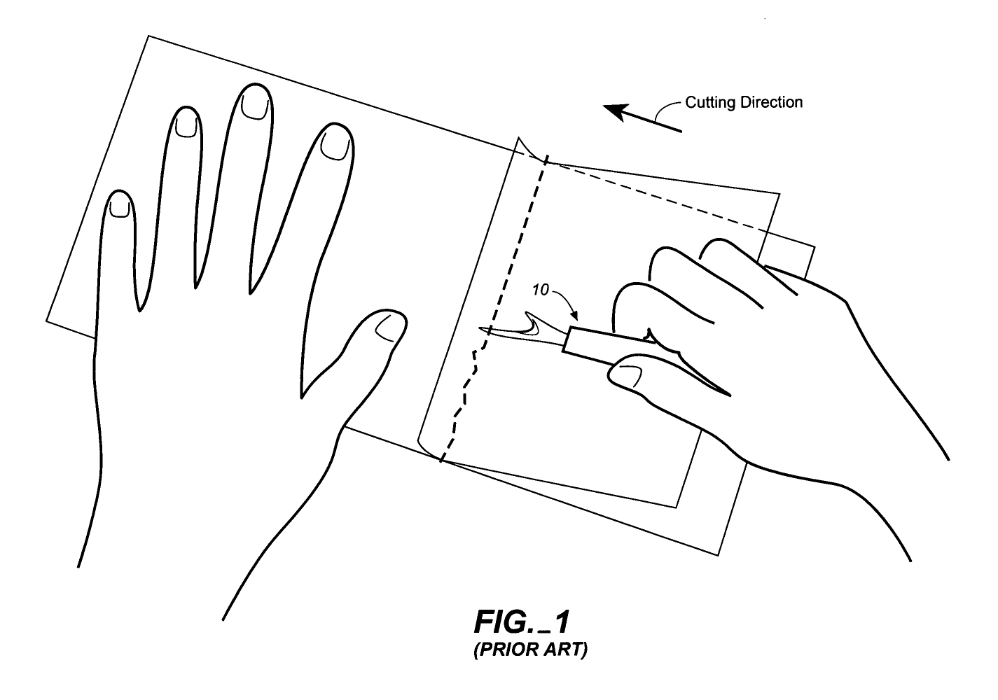

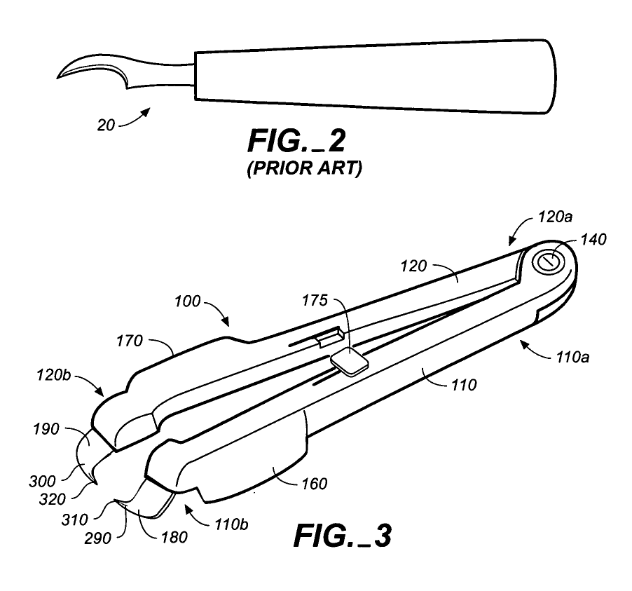

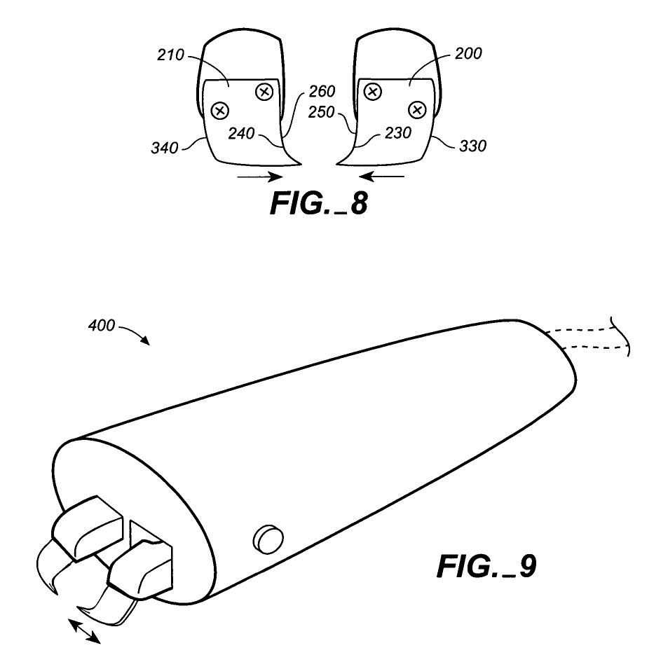

Referring now to FIGS. 1-16, wherein like reference numerals refer to like components in the various views, the seam ripper apparatus of the present invention provides a novel tool which is surprisingly simple on cursory examination. However, as indicated above, and as described below, there are numerous inventive features, express and inherent in the design, that represent an advance over the prior art conventional seam rippers, denominated 10 in FIG. 1, and the prior art surgical seam rippers, denominated 20 in FIG. 2.

The seam ripper of the present invention, generally denominated 100 herein, comprises first and second generally elongate arms 110 and 120, each having a grip (or proximal) end 110a and 120a, respectively, and a working (or distal) end 110b and 120b, respectively. The two elongate arms are pivotally joined together with a hinge pin 140. Further, each arm is formed to include a cavity in the proximal end for housing a coiled spring 150, or alternative bias means well known in art, which urges the arms apart when not locked by an arm lock 175 positioned medially along the length of the arms. Ergonomic thumb grips 160, 170, are formed in each of the arms near the working ends.

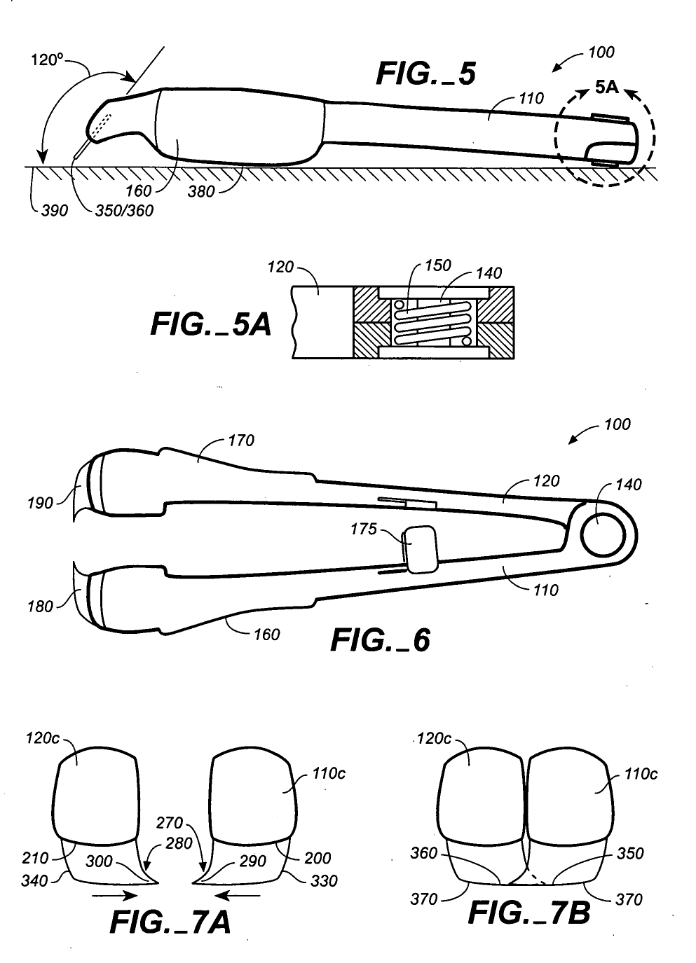

Referring now especially to FIGS. 5, and 6-8, each of the working ends includes a hooked blade 180, 190, affixed at an upper end 200, 210, respectively, to a distal end 110c, 120c, of an arm, and disposed downwardly from the distal end at an approximate 120 angle 220. The interior sides 230, 240 are each sharpened into a cutting edge which is in opposition to the cutting edge of the other blade and includes a straight or slightly curvilinear portion 250, 260, which angles sharply inward at its lower end 270, 280 to form a bevel 290, 300, terminating in a interior point 310, 320. Each bevel angles upwardly from its respective interior point toward the exterior side 330, 340 of the blade. The lower edges 350, 360 of the opposing blades are substantially coplanar 370 when in the closed position so that each blade complements the other in performing the work of prying thread upwardly from the fabric seam. However, referring now to FIG. 5, it will be seen that the blades do not extend downwardly farther than the bottom 380 of the thumb grips, so that when the tool is at rest on an article of fabric 390 the blades do not touch the fabric, thereby reducing the risk of damage to the fabric.

It will be noted that one or the other of the elongate arms is very slightly longer than the other arm, a distance of. This permits the blades to overlap very closely as the apparatus is squeezed by a user to place the apparatus in a cutting or closed configuration. However, the tolerances must be very close so that the apparatus cuts the stitching in the manner of a scissors. To ensure tight tolerances throughout the cutting action, the blades have a slightly curved shape from the exterior side to the interior side, the curve having a radius that corresponds to the radius of the radial closing motion as defined by the distance from the hinge pin to the distal end of each elongate arm.

FIG. 9 shows an alternative, motorized embodiment 400 of the inventive apparatus. The means of driving the arms radially are well known in the art. While this embodiment will not be favored by those needing precise control of the cutting process, some users with disabilities such as arthritis or carpal tunnel syndrome may need a mechanized device to reduce pain during use.

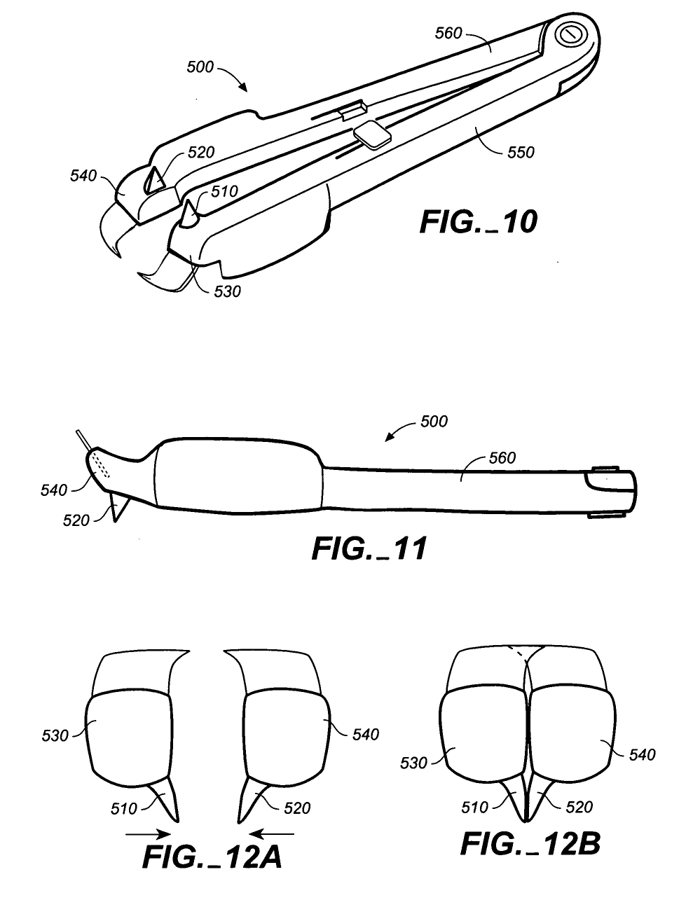

FIGS. 10-12B show a third preferred embodiment 500, which includes first and second tweezer faces 510, 520 each one disposed upwardly from a distal end 530, 540, of a respective arm 550, 560, such that the tool can be turned over to provide means to pull cut threads [see FIGS. 11-12B].

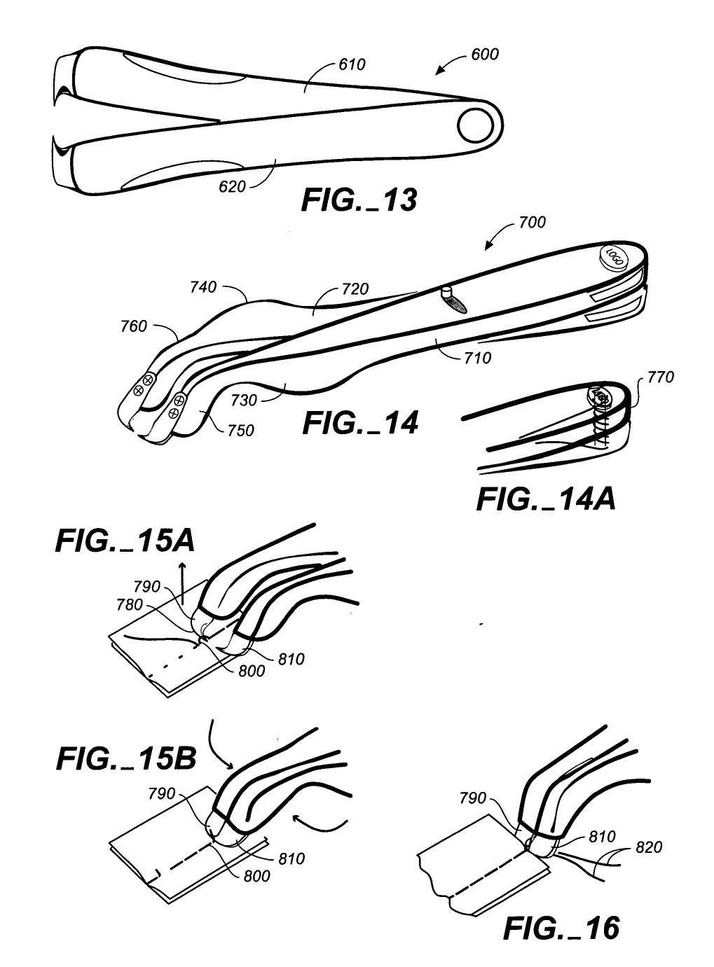

FIG. 13 shows a fourth preferred embodiment 600 of the inventive seam ripper having stacked upper and lower arm members 610, 620.

FIGS. 14-16 show a fifth preferred embodiment 700, also having stacked upper and lower arms 710, 720, and an elegant ergonomic design which includes both a bulge 730, 740, and a taper 750, 760 in each arm near the proximal ends of the arms to facilitate easy manipulation. This embodiment is essentially identical in function to the first three embodiments, though the use of a sliding bow spring 770 may be preferred over a coiled wire spring. Additionally, the stacked arrangement of the arms provides means to increase the amount of blade overlap during cutting. FIG. 15A shows this how the beveled end 780 of a blade 790 is employed to pry a tightly sewn thread 800, while FIG. 15B shows the radial motion of the arms then employed to cut the same thread with the hooked blades 790, 810. FIG. 16 shows the apparatus employed to cut loose thread ends 820.

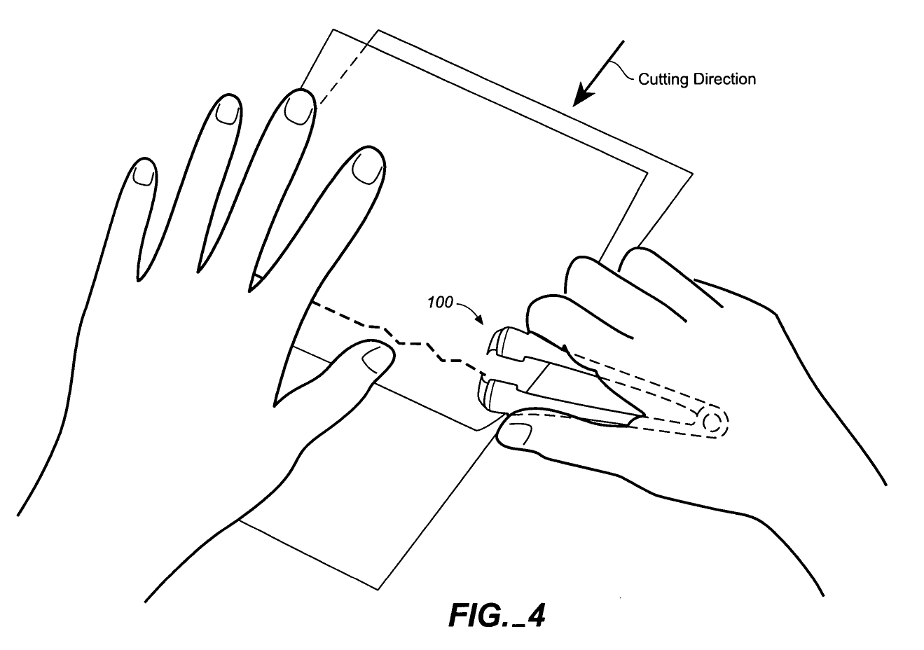

Of advantage, as indicated most clearly in FIGS. 3 and 4, the apparatus works with a simple pinching motion, clipping the threads with little effort with only one hand. Referring now to FIG. 4, the blades are angled down from their respective arms towards the seam so that while using the apparatus the hand travels in the same direction as the stitched seam and on the same plane as the fabric. Less hand rotation, twisting, fabric repositioning, and digging at the stitches is required. With the inventive apparatus it takes less time to rip a seam, with less physical stress to the user and less risk of damaging the fabric.

The polished points of the blades are designed to pull threads without cutting them, which is often the desired result when ripping a seam. The blade points, because of their design and beveled configuration, easily pry under dense SPI without damaging the fabric. Not until the arms are pinched and the two blades start to cross do the cutting edges contact the thread. At this time the blade points are beginning to overlap forming a closure surrounding only the thread and thus preventing the fabric from getting clipped.

The apparatus can be made in a variety of sizes each having a different aesthetic appeal and practical application. A smaller, more delicate version for very fine stitches would be suitable for shirtings, knits, quilting or embroidery. A medium-sized version with generic aesthetics and longer handles would be ideal for the majority of sewing uses. A larger version with handles curved for the shape of the hand, slightly larger blades, and having more of a traditional “tool box” look would be best for upholstery, automotive, leather, geotextile, and food service industries, to name only a few. The larger version may have handles made of wood or some tough resin grained like wood, though it will be appreciated by those with skill in the art that the handles could be fabricated from any of a number of suitable materials. In accordance, manufacturing methods include plastic injection molding for the handles and metal tooling for the blades. The same methods used to make conventional thread clippers can be applied to the inventive apparatus. Alternate designs include wooden or metal handles with appropriate hinge design, manufactured using well known fabrication and shaping methods.

Approximate measurements for the preferred embodiments of the basic apparatus would be 4½″ total length from the blades to the proximal end, both arms together measuring ¾″ in width when closed together, and each arm having a depth of ⅜″. These measurements exclude the shaped thumb grips.

The distance between the points of the blade when the apparatus is open is critical. For general sewing applications the opening is only 3/16″; otherwise control will be compromised. The blades tightly align adjacent to one other throughout the cutting process so that the apparatus operates to cut threads in the manner of a scissors. This also requires the blades to have a slightly curved shape with a radius that corresponds to the radius of the radial closing motion, so that as the blades overlap and cross, the clearance remains constant. With the handles fully closed the cutting edges of the blades overlap at approximately 3/32″.

Because of the scissors-like action, the inventive apparatus performs fast, safe and comfortable seam ripping, and it also trims loose thread ends. Cutting thread ends is difficult for conventional seam rippers that include a single blade and require pushing or sawing to tear the loose thread ends. With conventional seam rippers the user must have a thread clipper or scissors handy in order to trim loose thread ends.

As with any sharp tool, cuts and other injuries are a risk. Conventional seam rippers are often provided with a sheath or cover to prevent injury. However, the locking mechanism that keeps the inventive apparatus closed when not in use makes it safer than conventional seam rippers and obviates the need for a separate cover.

Conventional seam rippers are by their very nature forcefully moved back and forth relative to the user, in precisely the same fashion as a stabbing motion with a knife, and stab injuries to the user and to others can result. By contrast, and adding to the foregoing safety advantage, the configuration of the two opposing blades prevents the blades from being fully exposed and the motion of the blades is never directed to any other person or to any body part of the user (a finger, hand, or arm, for instance).

Furthermore, the unique design of the blades angled from the handles make clipping easier in many applications other than sewing. Such applications include, but are not limited to, gardening, surgical instruments, electrical wiring, construction work, crafts, shipping, gift wrap, and even pet grooming.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A handheld seam ripper apparatus having an open configuration and a closed configuration, said apparatus comprising:
a first arm having a proximal end and a distal end;
a second arm in opposition to said first arm and having a proximal end and a distal end and having a length slightly longer than said first arm;
a hinge pin disposed between and pivotally joining said first and second arms;
biasing means for urging said first and second arms apart and into an open configuration;
a first hooked blade having an upper end, a lower end, a interior side, and an exterior side, wherein a portion of said interior side is sharpened into a cutting edge and angles inwardly near said lower end to form a bevel which terminates in a interior point and which angles upwardly from said interior point toward said exterior side, said first hooked blade being affixed at said upper end to said distal end of said first arm such that said first hooked blade is disposed downwardly from said first arm; and
a second hooked blade having an upper end, a lower end, a interior side, and an exterior side, wherein a portion of said interior side is sharpened into a cutting edge in opposition to said interior side of said first hooked blade and which angles inwardly near said lower end to form a bevel which terminates in a interior point, said bevel angling upwardly from said interior point toward said exterior side, said second hooked blade being affixed at said upper end to said distal end of said second arm such that said second hooked blade is disposed downwardly from said second arm;
wherein when said first and second arms are urged together by a user from an open configuration to a closed configuration, said distal ends move radially toward one another and said blades overlap or cross to perform a scissors-like cutting action.

2. The apparatus of claim 1, wherein each of said arms includes a cavity in said proximal end and wherein said biasing means is a spring disposed around said hinge pin and housed in the cavities in each of said first and second arms.

3. The apparatus of claim 1, further including an arm lock to secure said apparatus in the closed configuration.

4. The apparatus of claim 1, further including first and second thumb grips formed in each of said first and second arms, respectively.

5. The apparatus of claim 1, wherein each of said thumb grips is disposed near said distal end of the arm.

6. The apparatus of claim 1, wherein said first and second hooked blades are each disposed downwardly at an approximate 120 degree angle.

7. The apparatus of claim 1, wherein each of said interior edges of said first and second hooked blades includes a straight or slightly curvilinear portion.

8. The apparatus of claim 1, wherein each of said hooked blades includes a lower edge and wherein said lower edges are substantially coplanar when said apparatus is in the closed position.

9. The apparatus of claim 1, wherein each of said first and second arms includes a thumb grip disposed near said distal end of its respective arm, and wherein each thumb grip includes a bottom, and wherein each of said first and second blades includes a lower edge, and wherein said first and second blades do not extend downwardly farther than said bottom of said thumb grips, such that when said apparatus tool is laid upon a planar surface, said lower edges of said first and second hooked blades do not contact the planar surface.

10. The apparatus of claim 1, wherein said biasing means is an electric motor.

11. The apparatus of claim 1, further including first tweezer face disposed upwardly from said distal end of said first arm, and a second tweezer face disposed upwardly from said distal end of said second arm, said tweezer faces in opposing configuration such that said apparatus can be inverted to provide means to pull cut threads.

12. The apparatus of claim 1, wherein said first and second arms are in a stacked configuration.

13. The apparatus of claim 12, wherein each of said arms includes a bulge and a taper distal to said bulge.

14. The apparatus of claim 1, wherein each of said hooked blades is slightly curved from said exterior side to said interior side, said curve generally conforming to the radius of said distal ends of said first and second arms when said apparatus is moved from the open configuration to the closed configuration.

15. A seam ripper apparatus having an open and a closed configuration, comprising:
a pair of opposed arms each having proximal and distal ends, said arms pivotally connected to one another around a hinge pin;
biasing means urging said arms apart; and
a pair of blades, one each disposed on said distal end of one of said arms, said blades having opposing interior cutting edges;
wherein said first and second arms are sized such that said first and second blades closely overlap to perform a scissors-like cutting action when said first and second arms are squeezed together into the closed configuration.

16. The apparatus of claim 15, wherein said first and second blades angle downwardly at an approximate 120 angle.

17. The apparatus of claim 15, wherein said first and second blades include a beveled lower portion for prying threads from a stitch.

18. The apparatus of claim 15, wherein each of said blades includes a lower portion that terminates in an inwardly disposed point.

19. The apparatus of claim 18, wherein said lower portions of said first and second blades includes a bevel.

20. The apparatus of claim 15, wherein said first and second hooked blades are selectively removable.
